(19) United States
(12) Patent Application Publication
(10) Pub. No.: US 2025/0292565 A1
(43) Pub. Date: Sep. 18, 2025

(54) INFORMATION PROCESSING APPARATUS AND CONTROL METHOD THEREFOR

(71) Applicant: CANON KABUSHIKI KAISHA, Tokyo (JP)

(72) Inventor: Shuhei OGAWA, Saitama (JP)

(21) Appl. No.: 19/075,019

(22) Filed: Mar. 10, 2025

(30) Foreign Application Priority Data
Mar. 13, 2024 (JP) 2024-038766

(51) Int. Cl. G06V 10/96; G06V 10/26

(52) U.S. Cl. CPC G06V 10/96; G06V 10/26

(57) ABSTRACT

An information processing apparatus for managing a plurality of learning models, comprises: a model management unit that manages, for each of the plurality of learning models, first information for identifying a data set used to learn the learning model, and second information for identifying an initial model used to learn the learning model; a data management unit that manages, for each of a plurality of data sets identified by the first information of each of the plurality of learning models, third information for identifying an initial data set used to create the data set; and a determination unit that determines, based on the first information, the second information, and the third information, at least one learning model and at least one data set used to learn a learning model of interest included in the plurality of learning models.

### BACKGROUND OF THE INVENTION

### Field of the Invention

The present invention relates to a technique for managing learning models and learning data.

### Description of the Related Art

In recent years, the accuracy of image recognition techniques such as image classification, object detection, and object tracking has remarkably been improved due to advent of a deep neural network (DNN). In general, to learn a DNN model, a large amount of data is required but it is difficult for individuals to collect such large amount of data. To cope with this, a method called fine tuning in which only some of the layers of a DNN model are learned by using, as an initial model, a model learned in advance using a large amount of data is sometimes performed. It is then expected that a user will perform incremental learning in accordance with his/her application by using, as an initial model, a learning model published by another user and publish a thus obtained learning model in the future.

Japanese Patent No. 6858082 (patent literature 1) discloses a technique of making it possible to identify a user (contributor) involved in creating a learning model by associating identification information for identifying the user with the learning model.

In learning a learning model, the contribution of not only an initial model but also data used is large. Therefore, for example, to publish, for a fee, a learning model created by incremental learning, it is desirable to set a compensation in consideration of the contribution of the user who has created (edited/added) the data used for incremental learning.

However, in the method disclosed in patent literature 1, the user involved in the model itself can be identified but the user involved in the data used (the data used to learn the initial model or the data used for incremental learning) cannot be identified. Thus, it is difficult to appropriately set a compensation for each user in order to publish the learning model.

### SUMMARY OF THE INVENTION

According to one aspect of the present invention, an information processing apparatus for managing a plurality of learning models, comprises: a model management unit that manages, for each of the plurality of learning models, first information for identifying a data set used to learn the learning model, and second information for identifying an initial model used to learn the learning model; a data management unit that manages, for each of a plurality of data sets identified by the first information of each of the plurality of learning models, third information for identifying an initial data set used to create the data set; and a determination unit that determines, based on the first information, the second information, and the third information, at least one learning model and at least one data set used to learn a learning model of interest included in the plurality of learning models.

The present invention makes it possible to identify data used to create a learning model.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the functional configuration of an information processing apparatus;

FIG. 2 is a view showing the procedure of processing in the information processing apparatus;

FIGS. 3A and 3B are flowcharts of learning processing in the information processing apparatus;

FIG. 4 shows tables each showing an example of information added to a model;

FIG. 5 shows tables each showing an example of information added to data;

FIG. 6 is a view showing an example of traceability information;

FIG. 7 is a view showing an example of learning data;

FIG. 8 is a view showing an example of editing of the learning data;

FIG. 9 is a block diagram showing the functional configuration of an information processing apparatus (second embodiment);

FIG. 10 is a flowchart of learning processing in the information processing apparatus (second embodiment);

FIG. 11 is a table showing an example of information added to a model (second embodiment);

FIG. 12 is a view showing an example of traceability information (second embodiment);

FIG. 13 is a view showing an example of learning data (modification); and

FIG. 14 shows tables each showing an example of information added to data (modification).

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

As the first embodiment of an information processing apparatus according to the present invention, an information processing apparatus that manages the history of learning models and learning data as traceability information will be exemplified below.

### Overview

When performing incremental learning for a learning model (learned model) using learning data, the information processing apparatus according to this embodiment manages information (a learning data ID) concerning the learning data used in association with a learning model obtained by incremental learning. In addition, in a case where the learning model is a derived model, the information processing apparatus manages information (an initial model ID) concerning an initial model used in association with the learning model. Furthermore, in a case where the learning model is a derived model, the information processing apparatus manages information (an initial data ID) concerning an initial data set used in association with the learning data. Thus, the information processing apparatus can identify a past learning model and learning data contributing to creation of the learning model created by incremental learning.

### Apparatus Configuration

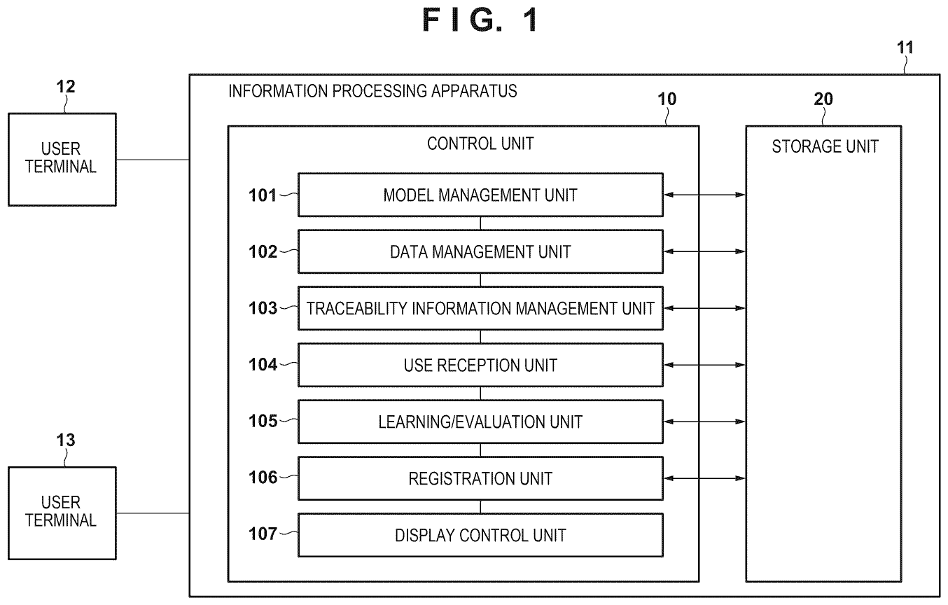

FIG. 1 is a block diagram showing the functional configuration of an information processing apparatus 11. The information processing apparatus 11 manages a “model” and “data” used to learn and evaluate the model. Furthermore, the information processing apparatus 11 learns a model, edits data, or registers model information in response to a request from a user. Assume here that the model and data can be used by the third party via a learning model public platform. That is, the user is a user of the learning model public platform.

The information processing apparatus 11 is connected in a communication-enabling manner to user terminals 12 and 13 via a communication network such as a local area network (LAN) or the Internet. The connection method is not particularly limited. For example, each user terminal may be connected via a wire or connected via wireless communication. Note that FIG. 1 shows two user terminals, but the present invention is not limited to this. Assume that each user terminal is an information terminal such as a personal computer (PC), a mobile phone, or a tablet terminal apparatus.

The information processing apparatus 11 includes a control unit 10 and a storage unit 20. The control unit 10 can be implemented when, for example, a central processing unit (CPU) executes various kinds of programs stored in the storage unit 20. The storage unit 20 is a random access memory (RAM), a read only memory (ROM), or a mass storage device such as a hard disk drive (HDD) or a solid-state drive (SSD).

The control unit 10 includes a model management unit 101, a data management unit 102, a traceability information management unit 103, a use reception unit 104, a learning/evaluation unit 105, a registration unit 106, and a display control unit 107. As described above, these functional units can be implemented when, for example, the CPU executes various kinds of programs. However, some or all of the functional units may be implemented by hardware such as an Application Specific Integrated Circuit (ASIC).

The model management unit 101 manages models registered in the information processing apparatus 11. This embodiment assumes that the model is an “object detection model” that aims at performing object detection as one form of image recognition, but the present invention is not limited to this. The model may be a speech recognition model, a natural language processing model, or a generative artificial intelligence (AI) model. The model management unit 101 manages the models by adding model information to each model.

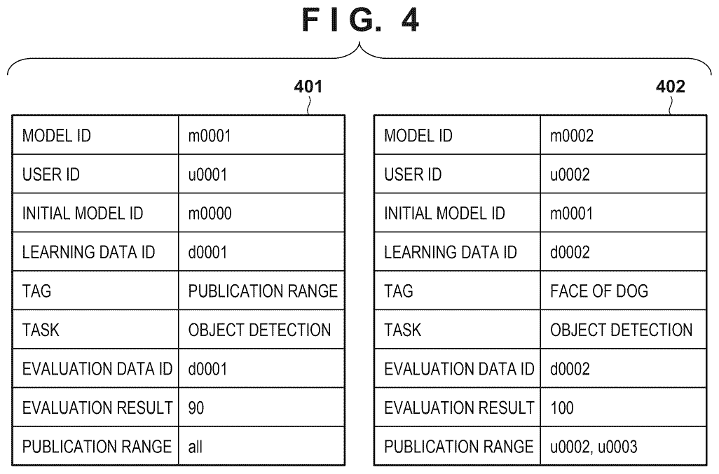

FIG. 4 shows tables of examples of model information 401 and model information 402 added to two models, respectively. The model information is attribute information of the model, and includes pieces of information of a model ID, a user ID, an initial model ID, a learning data ID, a tag, a task, an evaluation data ID, an evaluation result, and a publication range. That is, the model information includes pieces of identification information (IDs) for identifying the initial model and the data used to generate the model.

The model ID is model-specific identification information (ID) for identifying each model. The user ID is a user-specific ID (user information) for identifying a user who has performed learning for each model. The initial model ID is a model ID for designating a model that serves as an initial parameter when learning each model.

Referring to FIG. 4, in the model information 401, the model ID is “m0001” and the initial model ID is “m0000”. In the model information 402, the model ID is “m0002” and the initial model ID is “m0001”. Therefore, it is indicated that the model with the model ID “m0002” is a model obtained as a result of performing learning by using the model with the model ID “m0001” as the initial model.

The learning data ID is a learning data-specific ID for identifying a data set used to learn each model. In the tag, information of an object targeted by each model, information necessary for the user to search for a model, or the like is described. In the task, a type of processing (object detection, image generation, or the like) targeted by each model is described. The evaluation data ID is a data ID for designating a data set used to evaluate each model. In the evaluation result, a numerical value obtained as a result of evaluation or the like is described. In the publication range, information representing the publication range (a range within which publishing is permitted) of each model is described. For example, all (published to all (public)), private, or one or more user IDs are described. If a user ID is described, only a user having the described ID can access the model, and other users cannot access the model.

As shown in FIG. 4, the model information 401 or 402 is model information of a model for an object detection model. For example, if the model is a model of another type (a speech recognition model or the like), items included in the model information may be different from those in the example shown in FIG. 4.

The data management unit 102 manages data registered in the information processing apparatus 11. The data according to this embodiment is image data for object detection. The data management unit 102 receives registration of a data set from the user, and manages the data set by adding data information to the data set.

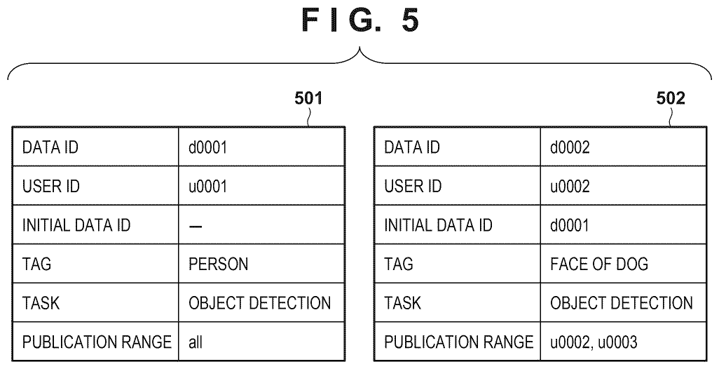

FIG. 5 shows tables showing examples of data information 501 and data information 502 added to data (image data sets), respectively. The data information is attribute information of data and includes pieces of information of a data ID, a user ID, an initial data ID, a tag, a task, and a publication range.

The data ID is a data-specific ID for identifying each piece of data. The user ID is a user-specific ID (user information) for identifying a user who has created each piece of data. The initial data ID is the data ID of an initial data set used to create the data. In the tag, information of an object targeted by each piece of data, information necessary for the user to search for data, or the like is described. In the task, a type of processing (object detection, image generation, or the like) targeted by each piece of data is described. In the publication range, information representing the publication range (a range within which publishing is permitted) of each piece of data is described. The described information is the same as that in the model information.

For example, the data information 501 is data information of data created by user 1 (ID is “u0001”), and the data information 502 is data information of data created by user 2 (ID is “u0002”). Since the initial data ID in the data information 502 is “d0001”, it is indicated that data corresponding to the data information 502 is created using data corresponding to the data information 501 as the initial data.

As shown in FIG. 5, the data information 501 or 502 is data information of data used for a model for an object detection model. For example, if the data is data used for a model of another type (a speech recognition model or the like), items included in the data information may be different from those in the example shown in FIG. 5.

The traceability information management unit 103 manages traceability information of models and data. The traceability information is information representing how the models and the data were created in the past (that is, the past history).

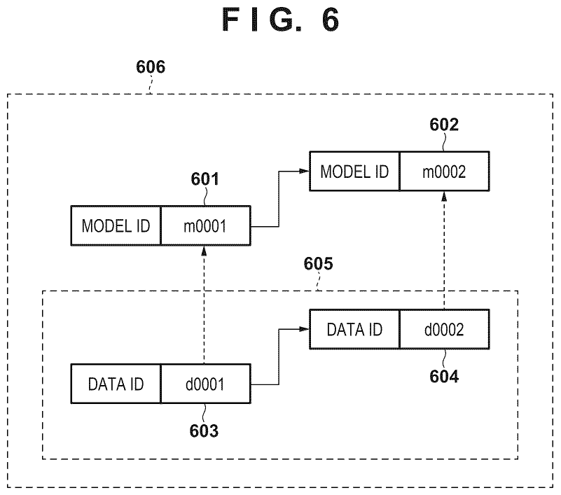

FIG. 6 is a view showing an example of the traceability information. Referring to FIG. 6, a solid arrow represents the derivative relationship between models or between data. That is, the relevance between a plurality of learning models published on the learning model public platform and the relevance between a plurality of data sets are integrated and managed. Referring to FIG. 6, a dotted arrow represents data used to learn each model.

For example, it is indicated that a model 601 (“m0001”) is a model learned by using data 603 (“d0001”). Furthermore, it is indicated that a model 602 (“m0002”) is a derived model created by performing incremental learning by using the model 601 (“m0001”) as the initial model and using data 604 (“d0002”). It is also indicated that the data 604 is derived data created (edited/added) based on the data 603.

As described above, the traceability information indicates records obtained by editing the models and the data in the past. By tracing the traceability information, it is possible to identify one or more models used to create each model. It is also possible to identify one or more data used to create each piece of data.

The use reception unit 104 receives a use request of a model or data from the user, and determines the availability of the model or data for the user. The availability is determined based on the traceability information managed by the traceability information management unit 103. The model or data that is determined to be available can be used in the learning/evaluation unit 105, and is used as the initial model or the learning data.

The learning/evaluation unit 105 learns or evaluates the model based on the model or data determined to be available by the use reception unit 104.

The registration unit 106 registers the model or data. For example, the registration unit 106 registers a new model created by incremental learning by the learning/evaluation unit 105. In addition, the registration unit 106 receives new data from the user, and registers it as new data. As described above with reference to FIGS. 4 and 5, if the model or data already registered by the registration unit 106 is used to create the model or data to be newly registered, the initial model ID or the initial data ID is registered together.

The display control unit 107 executes control to display the result of the information processing apparatus 11 for the request from the user terminal 12 or 13.

The storage unit 20 stores the above-described various kinds of programs executed by the CPU, and also stores the above-described models, model information, data, data information, and traceability information.

### Operation of Apparatus

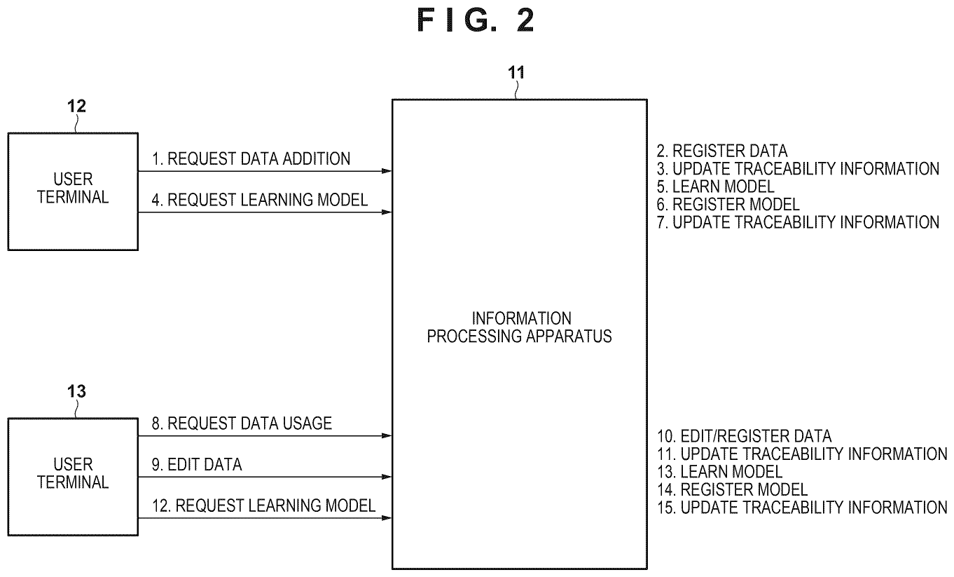

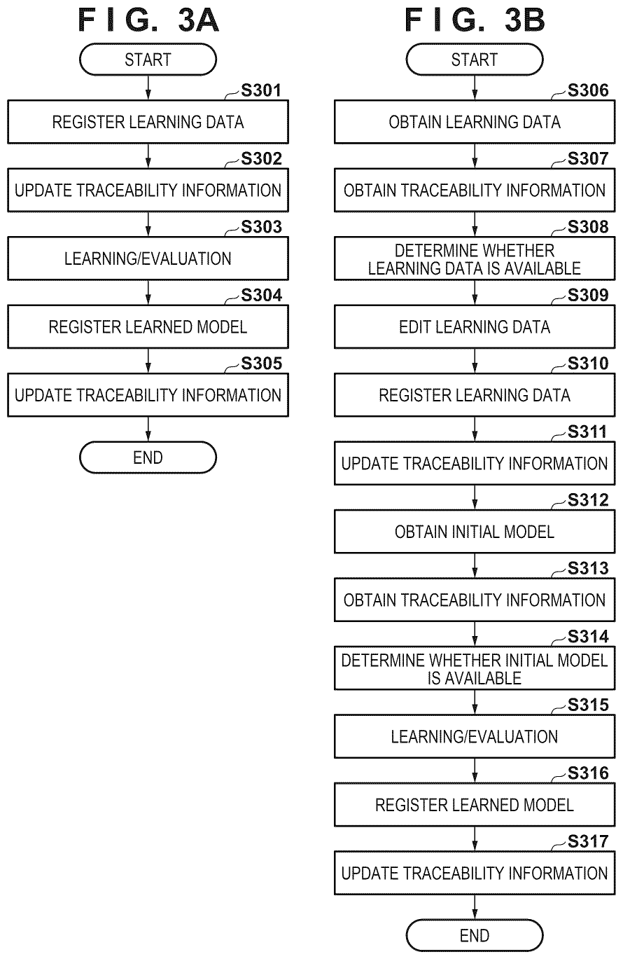

FIG. 2 is a view showing the procedure of processing in the information processing apparatus in response to a request from the user terminal. FIGS. 3A and 3B are flowcharts when learning and registering a model in the information processing apparatus 11. FIG. 3A is a flowchart when learning and registering a model based on a request from the user terminal 12. FIG. 3B is a flowchart when learning and registering a model based on a request from the user terminal 13.

As shown in FIG. 2, the following description assumes that user 1 operates the user terminal 12 to register the data 603 and the model 601. After that, user 2 operates the user terminal 13 to edit the data 603, create the data 604, and register it, and to register the model 602 obtained by performing incremental learning using the model 601 as the initial model.

Assume that the models 601 and 602 are, for example, object detection models to cause a camera to focus on an object of a predetermined type. A status in which user 1 “wants to detect a person and a dog (as objects of predetermined types)” is assumed. A status in which user 2 “wants to detect the face of a dog (as an object of a predetermined type)” is also assumed. The predetermined types of objects are not limited to these.

First, user 1 operates the user terminal 12 to request the information processing apparatus 11 to add learning data prepared in advance.

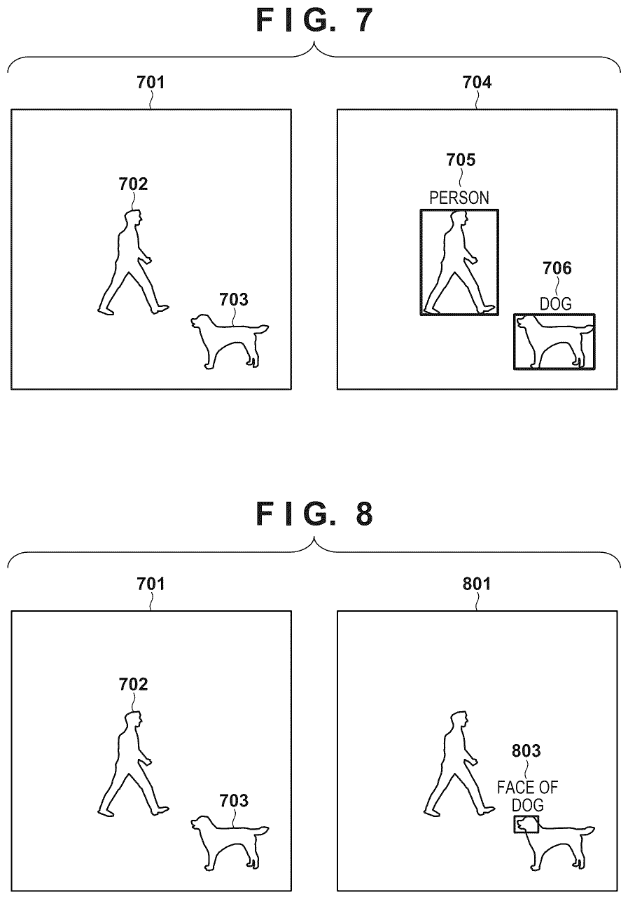

FIG. 7 is a view showing an example of learning data. The learning data includes an image 701 and a ground truth 704. The image 701 is an image including an object (in this example, a person 702 and a dog 703) which the user wants to recognize. To learn object detection, not only an image but also object information as a Ground Truth (GT) is necessary. The object information is, for example, bounding box information (BB information) corresponding to information of the position and size of a detection target object in the image. A BB 705 is a BB corresponding to the person 702 and a BB 706 is a BB corresponding to the dog 703. That is, the learning data includes one or more pairs of images and ground truths corresponding to the images.

In step S301, the registration unit 106 registers data in response to a data addition request from the user terminal 12 (user 1). The registered data is added with data information as indicated by the data information 501. Assume here that the data ID of the data registered by user 1 is “d0001”. User 1 can add the pieces of information of the publication range, tag, and task of the learning data together with a learning data registration request. Note that there is no initial data linked with the registered data in the data information 501, and thus the initial data ID is blank.

In step S302, the traceability information management unit 103 newly adds traceability information to the data registered in step S301. At this time, the information as indicated by the data 603 of FIG. 6 is registered as the traceability information. At this stage, not the information linked with the data 603 registered by user 1 but the data 603 is registered as the traceability information independently.

In step S303, the learning/evaluation unit 105 executes learning using the registered data in response to a learning execution request from the user terminal 12 (user 1). In this example, the learning/evaluation unit 105 receives designation of the initial model (“m0000”) from the user and executes learning for the model using the data (“d0001”). Note that the model with the model ID “m0000” is assumed to be registered in advance in the storage unit 20.

As a learning method of object detection, there is provided, for example, a method using a neural network (NN). Literature A describes details of the learning method of object detection using the NN. The learning/evaluation unit 105 may evaluate the data used for learning or the model learned using arbitrary data.
(Literature A) Tian et al., “FCOS: Fully Convolutional One-Stage Object Detection”, arXiv: 1904.01355, 2019

In step S304, the registration unit 106 registers the model learned in step S303 in the storage unit 20. When registering the model, for example, model information as indicated by the model information 401 is added. Note that the user ID is the user ID (“u0001”) of user 1 who is operating the user terminal 12.

In step S305, the traceability information management unit 103 updates the traceability information. Since the model (“m0001”) is learned using the data (“d0001”), information as indicated by the model 601 of FIG. 6 is registered. Furthermore, the linkage (dotted arrow) between the model (“m0001”) and the data (“d0001”) is registered.

As described above, the data (“d0001”) prepared by user 1 and the model (“m0001”) learned using the data are registered in the information processing apparatus 11.

Next, user 2 operates the user terminal 13 to request the information processing apparatus 11 to edit the data and learn the model using the data and the model registered by user 1.

In step S306, the use reception unit 104 obtains learning data in response to a data obtainment request from the user terminal 13 (user 2). In addition, the use reception unit 104 inquires of the data management unit 102 whether user 2 can use the data (“d0001”). Then, the data management unit 102 confirms the publication range of the data (“d0001”). In this example, the publication range is “all” (published to all).

In step S307, the traceability information management unit 103 confirms the traceability information of the data (“d0001”). As a result, with respect to the data (“d0001”), it is determined that there is no original initial data.

In step S308, the traceability information management unit 103 determines whether the data is available. The publication range of the data (“d0001”) is “all” in step S306, and there is no original initial data of the data in step S307. Therefore, it is determined that all users who can access the information processing apparatus 11 can use the data, and user 2 can use the data. Note that if it is determined in step S307 based on the traceability information that data set with a publication range within which the data is not published to user 2 is included, user 2 cannot use the data.

In step S309, the data management unit 102 edits the learning data in response to a request from the user terminal 13 (user 2).

FIG. 8 is a view showing an example of editing of the learning data. As described above, in this example, user 2 “wants to detect the face of a dog”. Thus, by using the image 701 of the data (“d0001”), a BB 803 is added, as a ground truth (GT) 801 corresponding to the image 701, to the face of a dog.

In step S310, the registration unit 106 registers the data edited by user 2. Data information added to the registered data (“d0002”) is as indicated by the data information 502. Note that as an example, the publication range is set to two users (“u0002” and “u0003”).

In step S311, the traceability information management unit 103 updates the traceability information. As described above, since the data (“d0002”) is created based on the data (“d0001”), traceability information 606 representing that the data 604 is derived data of the data 603 is created (updated).

In step S312, the use reception unit 104 receives an obtainment request of a model to be used as the initial model from the user terminal 13 (user 2). Assume here that user 2 uses, as the initial model, the model (“m0001”) created by user 1.

In step S313, the model management unit 101 confirms the model information 401 added to the model for which the obtainment request has been received. It is known that the publication range of the model (“m0001”) is “all”. In addition, the traceability information management unit 103 confirms the traceability information of the model. As a result, with respect to the model (“m0001”), it is determined that there is no original initial model.

In step S314, the traceability information management unit 103 determines whether the model is available. In step S313, the publication range of the model (“m0001”) is “all” and there is no original initial model of the model. Therefore, it is determined that all users who can access the information processing apparatus 11 can use the model, and user 2 can use the model. Note that if it is determined in step S313 based on the traceability information that a model set with a publication range within which the model is not published to user 2 is included, user 2 cannot use the model.

In step S315, the learning/evaluation unit 105 executes learning using the data registered in step S310 in response to a learning execution request from the user terminal 13 (user 2). In this example, the learning/evaluation unit 105 receives designation of the initial model (“m0001”) and executes learning for the model using the data (“d0002”). A learning/evaluation procedure is the same as in step S303.

In step S316, the registration unit 106 registers the model learned in step S315 in the storage unit 20. When receiving the registration of the model from user 2, for example, model information as indicated by the model information 402 is added. Note that the user ID is the user ID (“u0002”) of user 2 who is operating the user terminal 13. Note that as an example, the publication range is set to two users (“u0002” and “u0003”).

In step S317, the traceability information management unit 103 updates the traceability information. As described above, since the model (“m0002”) is created by performing incremental learning for the model (“m0001”), the traceability information 606 representing that the model 602 is a derived model of the model 601 is created (updated).

As described above, according to the first embodiment, when creating a new learning model (derived model) by performing incremental learning for the initial model using the learning data, the history of the learning models and the learning data is managed as the traceability information. Thus, with respect to an arbitrary learning model of interest (included in a plurality of learning models published on the learning model public platform), it is possible to identify one or more learning models and one or more data sets contributing to the creation of the learning model of interest.

Furthermore, with reference to the traceability information, it is possible to appropriately determine, based on the publication range of the past model and data used as the initial model and the initial data, whether another user can use the model and the data obtained by incremental learning. Note that the traceability information may be distributed and managed using blockchain technology instead of being unitarily managed by the information processing apparatus 11.

Note that in the above description, a set of an image and a ground truth has been exemplified as learning data but a set of an image and a ground truth need not always be used. For example, a set of a speech or text and a ground truth may be used or only an image, a speech, or text may be used. A combination of an image and text may also be possible. The present invention may be applied to not only image recognition like the above-described object detection but also prediction/recognition of time-series data or natural language processing such as text classification.

### Second Embodiment

The second embodiment will describe a method of calculating a usage fee when a learning model created by incremental learning is published on a learning model public platform and the third party uses the learning model.

Especially, in the following description, a method of determining, when user 3 uses a model (“m0002”) registered by user 2 in the first embodiment, a compensation paid by user 3 to users (user 1 and user 2) involved in creating the model will be described.

### Apparatus Configuration

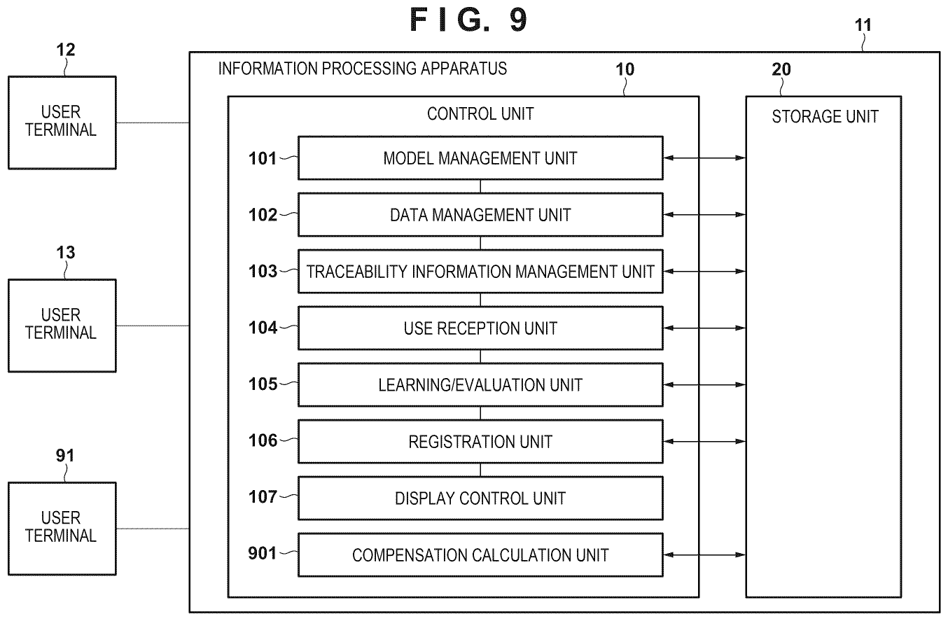

FIG. 9 is a block diagram showing the functional configuration of an information processing apparatus 11 according to the second embodiment. FIG. 9 is different from the first embodiment (FIG. 1) in that a user terminal 91 is added and a compensation calculation unit 901 is added to a control unit 10.

Assume that the user terminal 91 is a terminal operated by user 3, and the user ID of user 3 is “u0003”.

The compensation calculation unit 901 is a functional unit of calculating, by using traceability information, a compensation for using a published learning model. Although details will be described later, a compensation is calculated based on an initial model and data used to learn the learning model.

### Operation of Apparatus

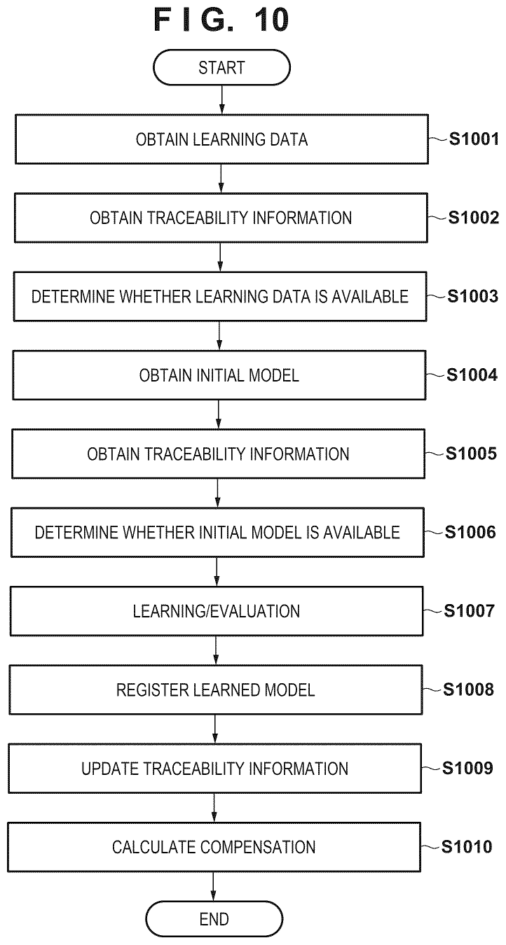

FIG. 10 is a flowchart of learning processing in the information processing apparatus according to the second embodiment. More specifically, FIG. 10 shows an operation when user 3 performs learning/evaluation using the model (“m0002”) and data (“d0002”) to create a new model.

In step S1001, a use reception unit 104 obtains learning data in response to a data obtainment request from the user terminal 91 (user 3). In addition, the use reception unit 104 inquires of a data management unit 102 whether user 3 can use the data (“d0002”). Thus, the data management unit 102 confirms the publication range of the data (“d0002”). As shown in FIG. 5, the publication range is “u0002, u0003”.

In step S1002, a traceability information management unit 103 confirms the traceability information of the data (“d0002”). As shown in FIG. 5, the original initial data of the data (the data ID is “d0002”) is data (“d0001”), and the publication range of the initial data is “all”.

In step S1003, the traceability information management unit 103 determines whether the data is available. The publication range of the data (“d0002”) is “u0002, u0003” in step S1001 and the publication range of the original initial data of the data is “all” in step S1002. Based on the logical product (AND) of the publication ranges, it is determined that user 3 can use the data (“d0002”).

In step S1004, the use reception unit 104 receives an obtainment request of a model to be used as the initial model from the user terminal 91 (user 3). Assume here that user 3 uses, as the initial model, the model (“m0002”) created by user 2.

In step S1005, a model management unit 101 confirms model information 402 added to the model for which the obtainment request has been received. The publication range of the model (“m0002”) is “u0002, u0003”. The traceability information management unit 103 confirms the traceability information of the model. As shown in FIG. 4, the original initial model of the model (“m0002”) is a model (“m0001”) and the publication range of the initial model is “all”.

In step S1006, the traceability information management unit 103 determines whether the model is available. In step S1005, the publication range of the model (“m0002”) is “u0002, u0003” and the publication range of the original initial model of the model is “all”. Based on the logical product (AND) of the publication ranges, it is determined that user 3 can use the model.

In step S1007, a learning/evaluation unit 105 executes learning using registered data in response to a learning execution request from the user terminal 91 (user 3). In this example, the learning/evaluation unit 105 receives designation of the model (“m0002”) as the initial model and executes learning using the data (“d0002”) for the model. A learning/evaluation procedure is the same as in step S303.

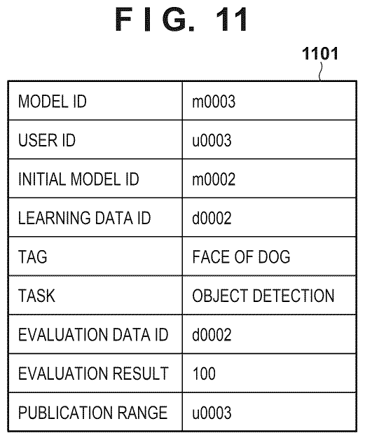

In step S1008, a registration unit 106 registers the model learned in step S1007 in a storage unit 20. When registering the model, for example, model information as indicated by model information 1101 is added. FIG. 11 is a table showing an example of the model information 1101 added to a model. Note that the user ID is the user ID (“u0003”) of user 3 who is operating the user terminal 91. Note that as an example, the publication range is set to user 3 (“u0003”) (that is, only the user himself/herself).

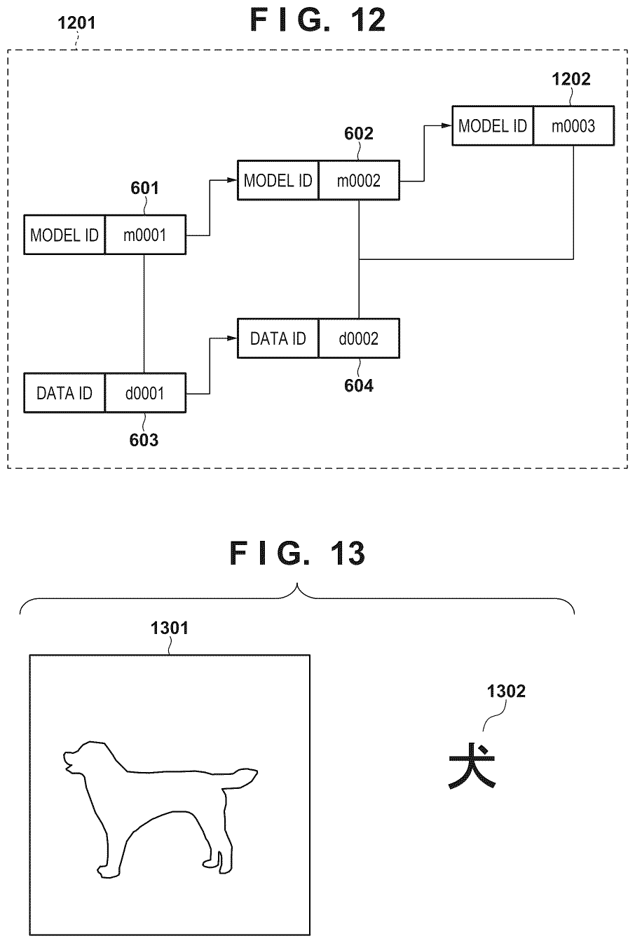

In step S1009, the traceability information management unit 103 updates the traceability information. As described above, since the model (“m0003”) is created by performing incremental learning for the model (“m0002”), traceability information 1201 representing that a model 1202 is a derived model of a model 602 is created (updated). FIG. 12 is a view showing an example of the traceability information 1201.

In step S1010, the compensation calculation unit 901 calculates a compensation paid when user 3 uses the model (“m0002”) and the data (“d0002”). First, the compensation calculation unit 901 traces the traceability information 1201 with respect to the model (“m0002”) and the data (“d0002”) to obtain model information and data information. Thus, it is possible to determine the past model and data contributing to the creation of the model and data. In this example, the data (“d0002”) is created based on the initial data (“d0001”). Furthermore, it is known that the initial model of the model (“m0002”) is the model (“m0001”). Therefore, user 2 (u0002) and user 1 (u0001) are identified based on the “user ID” description of the models (“m0002” and “m0001) and the data (“d0002” and “d0001”).

Note that the models and the data are weighted in advance based on the degrees of contribution. For example, the weight of the data is determined based on “the number of registered learning data” and the weight of the model is determined based on “the time required for learning” and the like. The amount of a specific compensation can be determined further based on the weights.

As described above, according to the second embodiment, when generating a new learning model (derived model) by performing incremental learning for the initial model using the learning data, the history of the learning models and the learning data is managed as the traceability information. Thus, it is possible to determine a usage fee (compensation) when the user uses the models and data registered by another user, in consideration of all users contributing to the creation of the models and data. That is, it is also possible to pay a compensation corresponding to the degree of contribution to a user contributing to the creation of the data in addition to the model.

### Modification

Each of the above-described embodiments has exemplified learning of an object detection model but the present invention can similarly be applied to learning of another type of model. As a modification, a form in which the present invention is applied to an image generation model used in an image generation task will be described. An image generation AI is image generation technology represented by literature B.
(Literature B) Rombach et al., “High-Resolution Image Synthesis with Latent Diffusion Models”, CVPR 2022, arXiv: 2112.10752, 2021

Note that the functional configuration and the operation of an information processing apparatus are the same as those in the first embodiment (FIGS. 1 to 3B) and a description thereof will be omitted. However, the modification is different in that a character string (text) is used as data of a ground truth used to learn a model, instead of a BB.

FIG. 13 is a view showing an example of learning data according to the modification. The learning data includes an image 1301 and a ground truth 1302. The image 1301 is an image including an object (in this example, a dog) which the user wants to recognize. To learn a model of an image generation task, not only an image but also object information as a ground truth (GT) is necessary. The object information is, for example, text representing an object in the image. As for the ground truth 1302, “a Kanji (Chinese) character meaning “dog”” is designated as text corresponding to the object included in the image 1301.

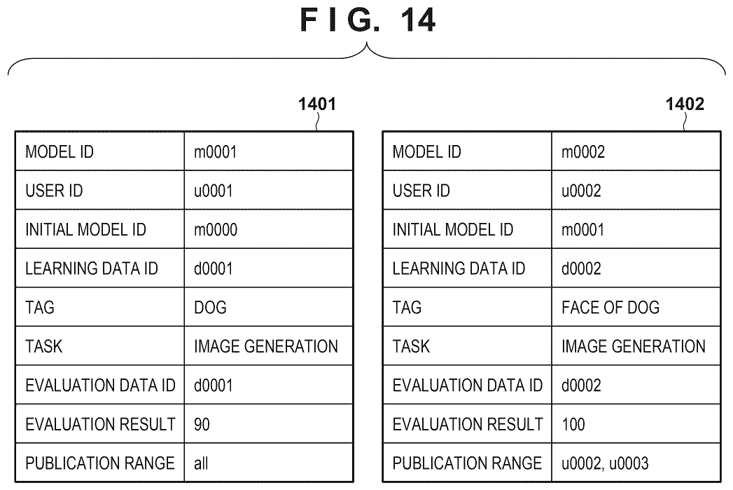

FIG. 14 shows tables each showing an example of information added to data according to the modification. Assume here that user 1 (u0001) creates the model (“m0001”) using the data (“d0001”) shown in FIG. 13 with respect to an initial model (“m0000”), and publishes the model on the learning model public platform. In this case, user 2 (u0002) who uses the learning model public platform can create the model (“m0002”) using the data (“d0002”) created by himself/herself with respect to the published model (“m0001”).

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-038766, filed Mar. 13, 2024 which is hereby incorporated by reference herein in its entirety.

What is claimed is:

1. An information processing apparatus for managing a plurality of learning models, comprising:
a model management unit that manages, for each of the plurality of learning models, first information for identifying a data set used to learn the learning model, and second information for identifying an initial model used to learn the learning model;
a data management unit that manages, for each of a plurality of data sets identified by the first information of each of the plurality of learning models, third information for identifying an initial data set used to create the data set; and
a determination unit that determines, based on the first information, the second information, and the third information, at least one learning model and at least one data set used to learn a learning model of interest included in the plurality of learning models.

2. The apparatus according to claim 1, further comprising:
a management unit that manages traceability information obtained by integrating relevance between learning models each generated based on the second information of each of the plurality of learning models, relevance between data sets each generated based on the third information of each of the plurality of data sets, and the first information of each of the plurality of learning models,
wherein the determination unit determines at least one learning model and at least one data set contributing to the learning model of interest based on the traceability information.

3. The apparatus according to claim 2, wherein the traceability information is distributed and managed by blockchain.

4. The apparatus according to claim 1, wherein
the model management unit further manages, for each of the plurality of learning models, first user information for identifying a user involved in learning the learning model,
the data management unit further manages, for each of the plurality of data sets, second user information for identifying a user involved in creating the data set, and
the determination unit further determines at least one user contributing to the learning model of interest based on the first information, the second information, the third information, the first user information, and the second user information.

5. The apparatus according to claim 4, further comprising:
a compensation calculation unit that calculates, based on at least one learning model and at least one data set contributing to the learning model of interest, a compensation for at least one user involved in the learning model of interest.

6. The apparatus according to claim 5, wherein
a preset weight is added to each of the plurality of learning models and the plurality of data sets, and
the compensation calculation unit calculates a compensation for the at least one user further based on the weight set for each of the at least one learning model and the at least one data set.

7. The apparatus according to claim 1, wherein
each of the plurality of data sets includes at least one pair of an image and a ground truth corresponding to the image.

8. The apparatus according to claim 7, wherein
in a case where the information processing apparatus is used to learn an object detection model, the ground truth is bounding box information of a detection target object included in the image.

9. The apparatus according to claim 7, wherein
in a case where the information processing apparatus is used to learn an image generation model, the ground truth is a character string indicating an object included in the image.

10. The apparatus according to claim 1, wherein
the plurality of learning models and the plurality of data sets are published via a model public platform,
the information processing apparatus further comprises a registration reception unit that receives registration of a second learning model created by performing incremental learning for a first learning model published on the model public platform, and
the registration reception unit registers, in the model management unit, identification information of the first learning model as the second information of the second learning model.

11. The apparatus according to claim 10, wherein
the registration reception unit further receives registration of a second data set created by using a first data set published on the model public platform, and
the registration reception unit registers, in the data management unit, identification information of the first data set as the second information of the second data set.

12. A control method for an information processing apparatus that manages a plurality of learning models, comprising:
obtaining, for each of the plurality of learning models, first information for identifying a data set used to learn the learning model, and second information for identifying an initial model used to learn the learning model;
obtaining, for each of a plurality of data sets identified by the first information of each of the plurality of learning models, third information for identifying an initial data set used to create the data set; and
determining, based on the first information, the second information, and the third information, at least one learning model and at least one data set used to learn a learning model of interest included in the plurality of learning models.

13. A non-transitory computer-readable recording medium storing a program that, when executed by a computer, causes the computer to perform a control method for an information processing apparatus that manages a plurality of learning models, comprising:
obtaining, for each of the plurality of learning models, first information for identifying a data set used to learn the learning model, and second information for identifying an initial model used to learn the learning model;
obtaining, for each of a plurality of data sets identified by the first information of each of the plurality of learning models, third information for identifying an initial data set used to create the data set; and
determining, based on the first information, the second information, and the third information, at least one learning model and at least one data set used to learn a learning model of interest included in the plurality of learning models.
